(19) United States
(12) Patent Application Publication
(10) Pub. No.: US 2026/0309733 A1
(43) Pub. Date: Oct. 8, 2026

(54) MODULAR RACK LIFTING EQUIPMENT AND RACK LIFTING SYSTEM

(71) Applicants: Roche Diagnostics GmbH, Mannheim (DE); Roche Diagnostics International AG, Rotkreuz ZG (CH)

(72) Inventors: Silvio Unternaehrer, Büttikon, Aargau (CH); Kentaro Sakata, Kanagawa (JP); Stefan Soentges, Stuttgart (DE); Daniel Arnold, Altdorf, Uri (CH); Jens Henning, Bietigheim-Bissingen (DE); Dai Takano, Tokyo (JP); Bauke Sjoerd Hollander, Zürich, Zurich (CH); Masaki Takahashi, Tokyo (JP); Marcel Kaeppeli, Merenschwand, Aargau (CH)

(21) Appl. No.: 19/482,574

(22) PCT Filed: May 8, 2024
(86) PCT No.: PCT/EP2024/062739

§ 371 Date: Nov. 7, 2025

(30) Foreign Application Priority Data
May 19, 2023 (JP) 2023-082836

(51) Int. Cl. G01N 35/04; G01N 35/02

(52) U.S. Cl. CPC G01N 35/04; G01N 35/026; G01N 2035/0465

(57) ABSTRACT

The object of the invention is to provide to provide modular rack lifting equipment and a rack lifting system which allow a conveyor path to be flexibly extended in a height direction and which can convey racks carrying sample containers in the vertical direction.

Solution

The object is achieved in that the modular rack lifting equipment of the present invention is characterised in having: a lifting unit including a basket loadable with a rack for holding sample containers and a drive mechanism for lifting and lowering the basket; a conveyor unit including a conveyor portion for conveying racks in a horizontal direction and a traverser for moving the racks loaded into the basket to the conveyor portion; and a support body for supporting the lifting unit and the conveyor unit. A plurality of said modular rack lifting equipment can be linked together.

### TECHNICAL FIELD

The present invention relates to a modular rack lifting equipment and rack lifting system for transporting racks holding sample containers.

### PRIOR ART

Automatic analysis equipment for qualitatively or quantitatively analysing biological samples of blood plasma, blood serum, urine, etc. is in widespread use in hospitals, as well as in test centres that receive requests for analysis from hospitals. The results of the biological specimen analysis are vital for diagnosing disease. In addition, in order to ensure efficient progress with analyses on the automatic analysis equipment, specimen conveying systems that automatically transport samples to a plurality of automatic analysis equipment are also widely used.

Furthermore, specimen testing systems that combine pre-processing equipment, such as centrifuges for separating blood serum and dispensers for subdividing specimens from parent containers to child containers, are widely used with sample conveying systems, especially by big hospitals and large-scale testing centres.

In the interests of transport efficiency, rack conveying equipment is often employed. Such equipment includes sample racks (abbreviated to “racks” below) which can hold and transport multiple sample containers.

Rack conveying equipment commonly includes, for example, a pair of guide rails provided along a predetermined conveyor path, and a belt conveyor that is provided between the guide rails and feeds in a predetermined direction.

If a plurality of conveyor lines are provided, they can be lined up within a horizontal area. When there are a large number of horizontally feeding conveyor lines, a problem arises in that the area occupied by the conveyor line installations grows large, leaving less free space in the room to install the sample processing system.

As a means to solve this problem, patent document 1 proposes holder conveyor equipment equipped with an elevator device, the elevator device including: an ascending and descending chain as a feed member disposed along a circulatory ascending and descending loop that has vertically extending ascending and descending paths; and a plurality of supporting plates supporting holders that hold sample containers in an upright state and are attached to the feed member

### PRIOR ART DOCUMENTS

### Patent Documents

Patent document 1 JP 2019-194578 A

### SUMMARY OF THE INVENTION

### Problems to Be Solved By the Invention

In the holder conveyor equipment according to patent document 1, although the elevator device can convey holders vertically, movement of the rack in the vertical direction is dependent on the designed height of the elevator, and the height cannot be changed according to the installation location. As such it is difficult to flexibly construct conveyor paths.

The purpose of the present invention is to provide modular rack lifting equipment and a rack lifting system which allow the conveyor path to be flexibly extended in the height direction, and which can convey racks carrying sample containers in the vertical direction.

### Means for Solving the Problem

To achieve the above purpose, the modular rack lifting equipment of the present invention includes: a lift unit equipped with a basket on which rack holding sample containers can be mounted, and a drive mechanism for lifting and lowering the basket; a conveyor unit equipped with a conveyor portion for conveying the rack in a horizontal direction, and a traverser for transferring the rack mounted in the basket to the conveyor portion; and a support body for supporting the lift unit and the conveyor unit, the modular rack lifting equipment being characterised by a plurality of modules which are configured to be linkable.

### Effect of the Invention

According to the present invention, is possible to provide a modular rack lifting device and rack lifting system which allow the conveyor path to be flexibly extended in the height direction, and which can convey racks carrying sample containers in the vertical direction.

### BRIEF DESCRIPTION OF THE DRAWINGS

FIG. 1 is a front view and cross-sectional view of the modular rack lifting equipment according to an embodiment of the present invention.

FIG. 2A is a front view of the changeover of a sample rack in the modular rack lifting equipment shown in FIG. 1.

FIG. 2B is an oblique view of the changeover of the sample rack in the modular rack lifting equipment shown in FIG. 1.

FIG. 3 shows a belt lift-up prevention mechanism of the conveyor portion of the modular rack lifting equipment shown in FIG. 1.

FIG. 4 is a partial view of a structure formed when pieces of the modular rack lifting equipment shown in FIG. 1 are linked together.

FIG. 5 shows a height position adjustment mechanism for the conveyor unit of the modular rack lifting equipment shown in FIG. 1.

FIG. 6 shows a rack lifting system composed of linked pieces of the modular rack lifting equipment in which the heights have been changed using the height position adjustment mechanism of the conveyor unit of the modular rack lifting equipment shown in FIG. 5.

FIG. 7 shows an example layout of a rack lifting system in which a plurality of modular rack lifting equipment has been linked.

### EMBODIMENTS OF THE INVENTION

Embodiments of the present invention are described in detail below with reference to the applicable drawings.

In the drawings, identical and similar elements are denoted using the same symbols. Duplicate explanations of such elements have been omitted. Note also that, as a matter of course, the scope of rights of this application is not limited to the embodiments described, but is determined based on the invention described in the claims of this application underpinned by the descriptions in the specification.

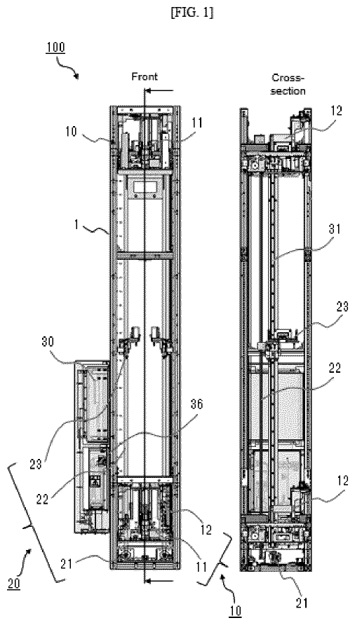

FIG. 1 shows the structure of modular rack lifting equipment 100 according to an embodiment of the present invention. The modular rack lifting equipment 100 includes a lifting unit 20 and a conveyor unit 10 on a support body 1. The lifting unit 20 is configured from a basket 23, on which can be mounted a sample rack 32 capable of holding five sample containers. The basket 23 is moved up and down along vertically provided guide rails 31 by a belt drive 22 and a motor 21.

The guide rails 31 may be a single rail or multiple rails, and can be installed for the purpose of both lifting and lowering the racks. The basket 23 is attached in such a way that it moves along each of the guide rails 31. The motor 21 is fixedly fitted to the support body 1, and is constructed so as only to lift and lower the basket 23.

The conveyor unit 10 is a unit for conveying the racks in a horizontal direction. Conveyor units 10 are arranged at both the top level and bottom level of each unit of the modular lifting rack equipment 100. The conveyor unit 10 includes a conveyor portion 11 configured using a belt or the like that conveys the sample rack 32 towards a predetermined conveyor path and a traverser 12, this being a mechanism for moving the sample rack 32, which has ascended or descended in the basket 23, out of the basket 23 and placing it on the conveyor portion 11, and/or moving the sample rack from the conveyor portion 11 and placing into basket 23.

The sample rack 32 is conveyed in the height direction by the lifting unit 20, transferred upon arriving at the destination to the conveyor portion 11 by the traverser 12, and then discharged from the conveyor portion 11 onto a predetermined conveyor path. A motor 21 of the lifting unit 20, the conveyor portion 11 of the conveyor unit 10 and the traverser 12 are controlled by a control portion 30, and the control portion 30 is connected to a power supply 36.

From the perspective of curbing cost, ease installation and the like, the height-wise size of the modular rack lifting equipment described with reference to FIG. 1 is preferably uniform. For example, said height could be around 2 m. However, it goes without saying that the module height can be set as appropriate in consideration of ease of production, transport, installation, etc., of said modular rack lifting equipment.

In addition, the conveyor unit 10 within the modular rack lifting equipment 100 can be arranged on the upper or lower level as appropriate and without restriction.

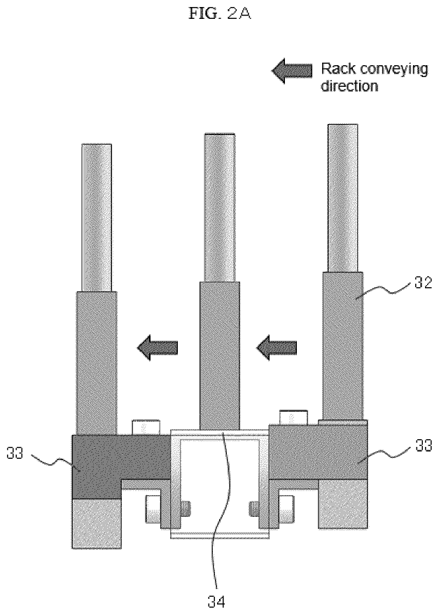

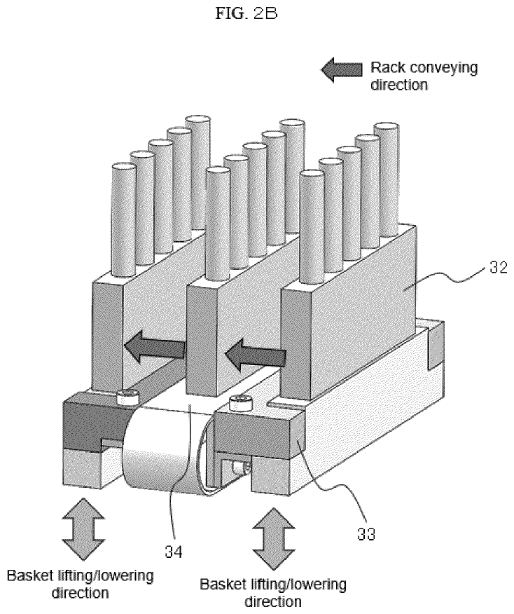

FIGS. 2A and 2B (hereinafter referred to collectively as FIG. 2) show a changeover of the sample rack 32 in the modular rack lifting equipment 100. The sample rack 32 is moved from an upper location to a lower location in the basket 23 positioned to the right-hand side, which is not depicted the drawing. Then, as shown in FIG. 1, the sample rack 32 is moved horizontally by the traverser 12 and transferred to the conveyor portion 11.

When the sample rack 32 is fed by the traverser 12 from the basket 23 to the conveyor portion 11 or from the conveyor portion 11 to the basket 23, any height difference can cause the rack 32 to snag and tip over, preventing the transfer and damaging the samples themselves.

By contrast, the modular rack lifting equipment 100 according to the present invention includes a step block 33 for providing a slightly high or low step in accordance with the movement direction. A plurality of the step blocks 33 with different heights are prepared in advance, and the various step blocks 33 are then employed as appropriate to easily adjust the height-direction in accordance with the direction of transfer of the sample rack 32, thus enabling a suppression of tip-over of the sample rack 32.

In the example illustrated in FIG. 2, in order to transfer from the basket 23 on the right-hand side to a conveyor belt 34 of the central conveyor portion 11, a step block 33 is provided to position the stop surface of the sample rack 32, shown on the right hand side, slightly higher than the surface of the conveyor portion 11. Conversely, in order to transfer the sample rack 32, shown on the left-hand side, from conveyor portion 11 to the basket 23, a step block 33 is provided to position the stop surface of the sample rack 32, shown on the left-hand side, slightly lower than the upper surface of the conveyor belt 34 of the conveyor portion 11. By using this configuration, the above-described benefits can be realised.

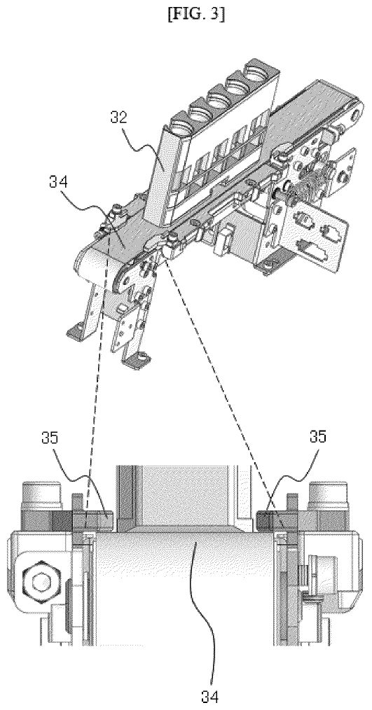

FIG. 3 is a view of a belt lift-up prevention mechanism 35 of the conveyor portion 11 of the modular rack lifting equipment 100. The belt lift-up prevention mechanism is provided so that, when the sample rack 32 is moved to the conveyor portion 11 by the traverser 12 due to deflection or floating of the conveyor belt 34 of the conveying unit 11, the rack 32 does not catch on the conveyor belt 34, and conversely, so that the step in the transfer from the conveyor portion 11 is not needlessly large.

The belt lift-up prevention mechanism 35 includes a protrusion, and is provided in a position at which it does not interfere when the sample rack 32 is moved to the conveyor portion 11 by the traverser 12, and at which it does not interfere with the conveying of the sample rack 32. The protrusion which protrudes from a portion above the side surface of the conveyor belt 34 is a guide that suppresses the lifting-up of the conveyor belt 34.

The conveyor belt 34 normally forms a loop with end portions thereof connected. As a consequence, the connection portion is thicker than other parts of the belt. The belt lift-up prevention mechanism 35 is particularly effective when the connection portion happens to coincide with the conveyor path of the conveyor portion 11.

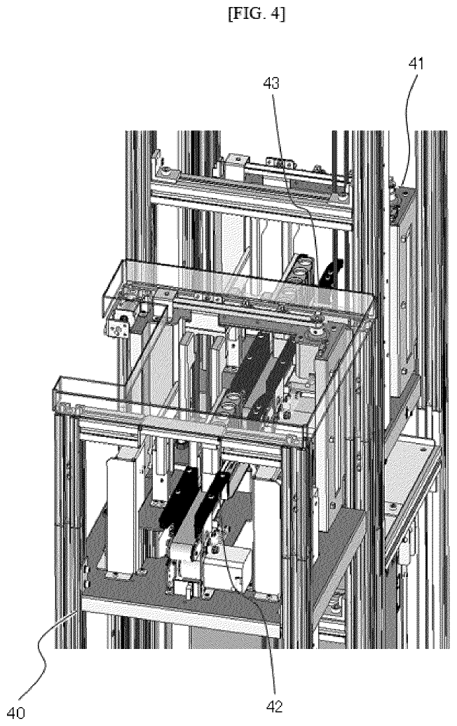

FIG. 4 is a partial view of a structure formed by linking together the modular rack lifting equipment 100. The structure is adjusted such that an upper surface of the conveyor portion 11 in a conveyor unit 42 of the conveyor unit of first modular rack lifting equipment 40 and an upper surface of the conveyor portion 11 of a conveyor unit 43 of second modular rack lifting equipment 41 are at the same height, the structure also being fixed together by fastening together connector components that are fastened to the respective supporting bodies 1. By connecting the modular rack lifting equipment in this way, it is possible to flexibly configure a system that can convey sample racks in a target height direction.

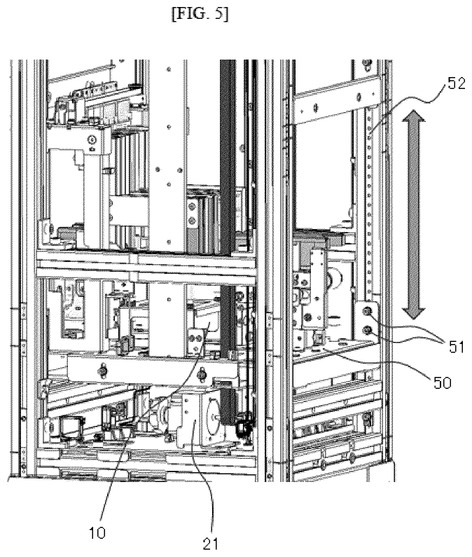

FIG. 5 shows a height position adjustment mechanism for the conveyor unit 10 of the modular rack lifting equipment 100. As shown in FIG. 5, in the conveyor unit 10 disposed at the lower level of the modular rack lifting equipment 100, the traverser 12 and the conveyor portion 11 of the sample rack 32 are attached to a same baseplate 50, being fixed to said baseplate 50 in a height adjustable manner by a plurality of bolts 51 and bolt receivers 52. As such, the height of the conveyor unit 10 can be adjusted, thus allowing free adjustment of the conveyor path length in the height direction.

The sample rack lifting equipment of the prior art was configured such that the entire conveyor unit 10, including the motor 21 and conveyor belt pulley, were lifted and lowered. On the other hand, with the modular rack lifting equipment 100 of the present invention, the heavy and bulky motor 21 and the like are fixed to the support body 1, and do not affect the height adjustment of the conveyor unit 10. It is therefore easier to make height adjustments. If both the fixtures of the conveyor unit 10 of lower-level part shown in FIG. 5 and that of the upper-level part have the same structure, it is possible to adjust the conveyor path length in the height direction from both the top and bottom sides, thus increasing to the degree of freedom of the adjustment.

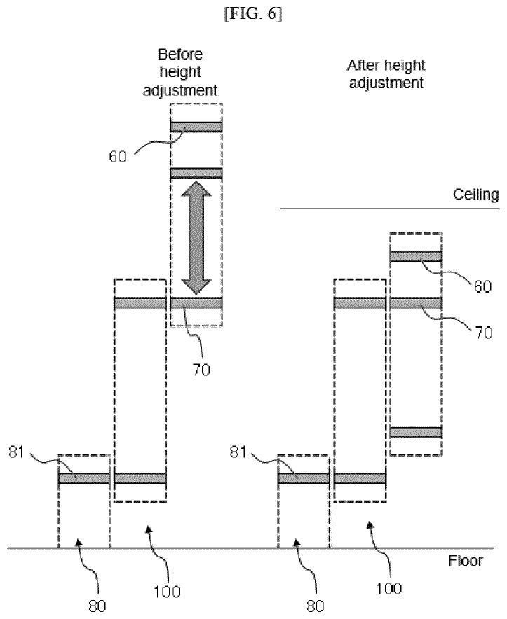

FIG. 6 shows a modular rack lifting system composed of linked pieces of the modular rack lifting equipment 100 in which the heights have been changed using the above-described height position adjustment mechanism of the conveyor units 10 of the pieces of modular rack lifting equipment 100. Since the height-direction positions of the conveyor units 10 can be appropriately and easily adjusted to the positions denoted by 60, 70, it is possible to take into consideration the floor space and ceiling height of the installation space and adjust the conveyor heights to suit the location, making use of a plurality of the modular rack lifting equipment 100 adjusted to have a uniform length in the height direction. Of note here, the modular rack lifting equipment 100 is connected to and used together with sample processing equipment 80 and a rack conveyor path 81.

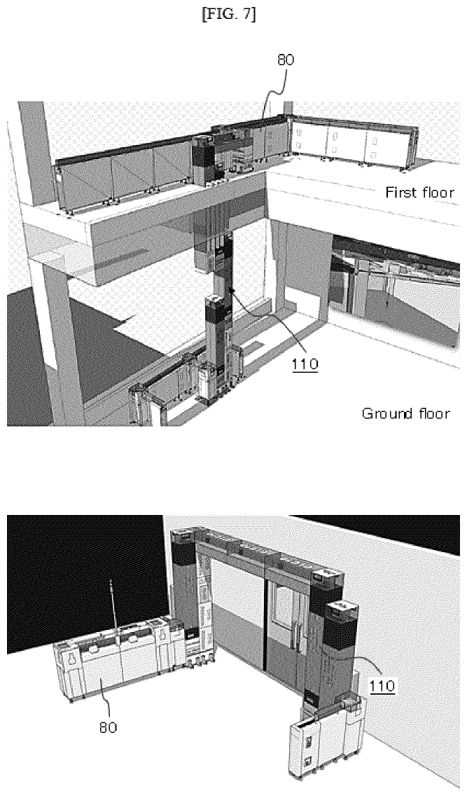

FIG. 7 shows an example layout of a rack lifting system 110 in which a plurality of modular rack lifting equipment 100 has been linked.

The upper part of FIG. 7 shows an example in which pieces of the modular rack lifting equipment 100 are connected to configure a height-direction conveyor path from a ground floor to a first floor where the sample processing equipment 80 is located. With such an arrangement, it is possible to effectively utilise the floor space, and efficiently implement the conveying and processing of the samples.

The lower part of the figure shows an example in which the modular rack lifting equipment 100 and a conventional conveyor route have been linked to configure a conveyor route that utilises the space around a door without interfering with the opening and closing of the door. By using the modular rack lifting equipment of standardised size according to this embodiment of the present invention, it is thus possible to realise a flexible system for conveying samples to a freely selected height.

### DESCRIPTION OF SYMBOLS

1 Support body
10 Conveyor unit
11 Conveyor portion
12 Traverser
20 Lifting unit
21 Motor
22 Belt drive
23 Basket
30 Control unit
31 Guide rails
32 Sample rack
33 Step block
34 Conveyor belt
35 Belt lift-up prevention mechanism
36 Power supply
40 First modular rack lifting equipment
41 Second modular rack lifting equipment
42 Conveyor unit of first modular rack lifting equipment
43 Conveyor unit of second modular rack lifting equipment
50 Baseplate
51 Bolt
52 Height adjustment bolt receiver
60 Upper conveyor unit
70 Lower conveyor unit
80 Sample processing equipment
100 Modular rack lifting equipment
110 Rack lifting system configured from a plurality of linked modular rack lifting equipment

1. Modular rack lifting equipment comprising: a lifting unit including a basket loadable with a rack for holding sample containers and a drive mechanism for lifting and lowering the basket;
a conveyor unit including a conveyor portion for conveying racks in a horizontal direction and a traverser for moving the racks loaded into the basket to the conveyor portion; and
a support body for supporting the lifting unit and the conveyor unit, wherein a plurality of modular rack lifting equipment are configured in a linkable manner, so that the conveyor path is flexibly extended in the height direction.

2. The modular rack lifting equipment according to claim 1, wherein
the drive mechanism is a belt drive configured with a motor unit of the belt drive fixed to the support body so that the basket alone is lifted and lowered.

3. The modular rack lifting equipment according to claim 1, wherein
the conveyor unit is attached to the support body in a manner that allows adjustment of a height-direction position.

4. The modular rack lifting equipment according to claim 1, wherein
the conveyor unit includes a step block for adjusting a height of the traverser, the step block allowing a stop surface of the basket to be set at a height above a height of the conveyor portion, or allowing the stop surface of the basket to be set at a height below a height of the conveyor portion.

5. The modular rack lifting equipment according to claim 1, wherein
the conveyor unit includes a belt lift-up prevention mechanism for suppressing upward movement of a conveyor belt of the conveyor portion, the belt lift-up prevention mechanism being provided at a position that avoids interference when sample racks are moved onto the conveyor portion by the traverser and that avoids interference with conveying of sample racks.

6. A rack lifting system configured by linking a plurality of the modular rack lifting equipment according to claim 1.

7. The rack lifting system according to claim 6, wherein
positions of the conveyor units of the modular rack lifting system are adjustable, and a target lifting height suitable for an installation location is achieved.

8. Modular rack lifting equipment according to claim 1, wherein the conveyor portion that allows racks, which have been loaded into the basket via a connection portion, to be conveyed in a horizontal direction between different rack lifting modular rack lifting equipment when side portions of the support bodies of a plurality of the modular rack lifting equipment have been linked.

9. The modular rack lifting equipment according to claim 8, wherein height-direction lengths of the plurality of rack lifting modular rack lifting equipment are all roughly the same.

10. The modular rack lifting equipment according to claim 8, wherein
the driving mechanism lifts and lowers the baskets by driving a belt between pulley mechanisms provided at upper and lower ends of the support body.

11. The modular rack lifting equipment according to claim 8, wherein
the conveyor portions on the support bodies are attachable at positions of varying heights.
